(19) United States
(12) Patent Application Publication
(10) Pub. No.: US 2025/0212054 A1
(43) Pub. Date: Jun. 26, 2025

(54) SELECTIVELY BOOSTING RADIO FREQUENCY SIGNALS OF WIRELESS BASE STATIONS

(71) Applicant: AT&T Intellectual Property I, L.P., Atlanta, GA (US)

(72) Inventors: Wasib Khallil, Lilburn, GA (US); Bhumit Patel, Woodstock, GA (US); Tanvi Alam, Roswell, GA (US); Jonathan Chang, Atlanta, GA (US)

(21) Appl. No.: 18/391,589

(22) Filed: Dec. 20, 2023

(51) Int. Cl. H04W 28/02

(52) U.S. Cl. CPC H04W 28/0289; H04W 28/0273

(57) ABSTRACT

A method performed by a processing system including at least one processor includes monitoring uplink traffic conditions and downlink traffic conditions in a plurality of nodes emitting radio frequency signals in a wireless communications network, determining, based on the monitoring and for each node of the plurality of nodes, an unused uplink capacity and an unused downlink capacity, sorting the plurality of nodes into a plurality of subsets, based on the unused uplink capacity and the unused downlink capacity, and boosting a first subset of the radio frequency signals emitted by a first subset of the plurality of subsets, without boosting a second subset of the radio frequency signals emitted by a second subset of the plurality of subsets.

The present disclosure relates generally to wireless communications and relates more particularly to devices, non-transitory computer-readable media, and methods for selectively boosting the radio frequency signals of wireless base stations.

### BACKGROUND

Fifth generation (5G) radio frequencies include frequencies in the millimeter wave band, which is found in the range of 24 GHz to 40 GHz. Millimeter wave frequencies provide higher bandwidth and data speeds than low- and mid-band radio frequencies, such as those radio frequencies used by fourth generation (4G networks).

### SUMMARY

In one example, the present disclosure describes a device, computer-readable medium, and method for selectively boosting the radio frequency signals of wireless base stations. For instance, in one example, a method performed by a processing system including at least one processor includes monitoring uplink traffic conditions and downlink traffic conditions in a plurality of nodes emitting radio frequency signals in a wireless communications network, determining, based on the monitoring and for each node of the plurality of nodes, an unused uplink capacity and an unused downlink capacity, sorting the plurality of nodes into a plurality of subsets, based on the unused uplink capacity and the unused downlink capacity, and boosting a first subset of the radio frequency signals emitted by a first subset of the plurality of subsets, without boosting a second subset of the radio frequency signals emitted by a second subset of the plurality of subsets.

In another example, a non-transitory computer-readable medium stores instructions which, when executed by a processor, cause the processor to perform operations. The operations include monitoring uplink traffic conditions and downlink traffic conditions in a plurality of nodes emitting radio frequency signals in a wireless communications network, determining, based on the monitoring and for each node of the plurality of nodes, an unused uplink capacity and an unused downlink capacity, sorting the plurality of nodes into a plurality of subsets, based on the unused uplink capacity and the unused downlink capacity, and boosting a first subset of the radio frequency signals emitted by a first subset of the plurality of subsets, without boosting a second subset of the radio frequency signals emitted by a second subset of the plurality of subsets.

In another example, a device includes a processor and a computer-readable medium storing instructions which, when executed by the processor, cause the processor to perform operations. The operations include monitoring uplink traffic conditions and downlink traffic conditions in a plurality of nodes emitting radio frequency signals in a wireless communications network, determining, based on the monitoring and for each node of the plurality of nodes, an unused uplink capacity and an unused downlink capacity, sorting the plurality of nodes into a plurality of subsets, based on the unused uplink capacity and the unused downlink capacity, and boosting a first subset of the radio frequency signals emitted by a first subset of the plurality of subsets, without boosting a second subset of the radio frequency signals emitted by a second subset of the plurality of subsets.

### BRIEF DESCRIPTION OF THE DRAWINGS

The teachings of the present disclosure can be readily understood by considering the following detailed description in conjunction with the accompanying drawings, in which:

FIG. 1 illustrates an example network, or system, in which examples of the present disclosure may operate;

FIG. 2 illustrates a flowchart of an example method for selectively boosting the radio frequency signals of wireless base stations, in accordance with the present disclosure;

FIGS. 3A-3D illustrate a portion of an example network in which a repeater of the present disclosure is positioned to detect radio frequency signals emitted by both a first radio frequency node and a second radio frequency node; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure selectively boosts the radio frequency signals of wireless base stations. As discussed above, 5G radio frequencies include frequencies in the millimeter wave band, which is found in the range of 24 GHz to 40 GHz. Millimeter wave frequencies provide higher bandwidth and data speeds than low- and mid-band radio frequencies, such as those radio frequencies used by 4G networks; however, the coverage (e.g., the distance over which the strength of the radio frequency signals can sustain a call or data session) of millimeter wave radio frequencies is not as great as the coverage of these lower frequency bands due to relatively higher incidence of path loss.

The coverage of millimeter wave frequencies can be increased by using a repeater to boost the millimeter wave signals emitted by a network base station node (e.g., a gNodeB). However, conventional repeaters are designed to boost the signals of a single node; thus, a repeater would need to be deployed for every node whose signals are to be boosted, which increases network infrastructure costs. Moreover, conventional repeaters are “dumb” devices in the sense that the repeaters merely detect signals being emitted by a node and boost them, regardless of the node's current capacity to handle more traffic. Thus, a conventional repeater will not be able to detect when the node to which the repeater is connected is operating at or near the node's maximum capacity (e.g., serving a maximum number of users that can be supported without degradation in performance), and will continue to boost the signals emitted by the node, which may lead to overloading of the node. This may cause end users to experience delays accessing data, applications, and the like. These delays may be magnified in situations where large groups of people congregated in a relatively small physical space are all trying to access the same node or nodes, such as at might be the case during a concert, a sporting event, a parade, or the like.

Examples of the present disclosure provide an intelligent repeater that can communicate with and boost the signals emitted by multiple millimeter wave nodes in order to extend the coverage of a communication network. In particular, the intelligent repeater can detect the respective capacities of the multiple millimeter wave nodes and can identify which millimeter wave nodes have unused capacity. The intelligent repeater can then boost the signals emitted by one or more of the millimeter wave nodes that have unused capacity, while not boosting the signals emitted by millimeter wave nodes whose respective capacities are at or near their limits. This ensures that user endpoint devices will continue to experience high data speeds, while also improving the coverage of the millimeter wave signals. The intelligent repeater may continuously monitor conditions at the multiple millimeter wave nodes, and dynamically adjust the selection of the millimeter wave nodes whose signals are boosted or not boosted in response to changes in conditions.

In further examples, the intelligent repeater may be able to determine whether the unused capacity associated with any millimeter wave node of the millimeter wave nodes is uplink capacity or downlink capacity. When selecting which of the multiple millimeter wave nodes should have their respective signals boosted, the intelligent repeater may choose to boost specifically the uplink signals of a millimeter wave node, but not the downlink signals (or vice versa). For instance, the intelligent repeater could choose to boost the uplink signals (but not the downlink signals) of a first millimeter wave node, while simultaneously boosting the downlink signals (but not the uplink signals) of a second, separate millimeter wave node in order to optimize the coverage and speed of the communications network.

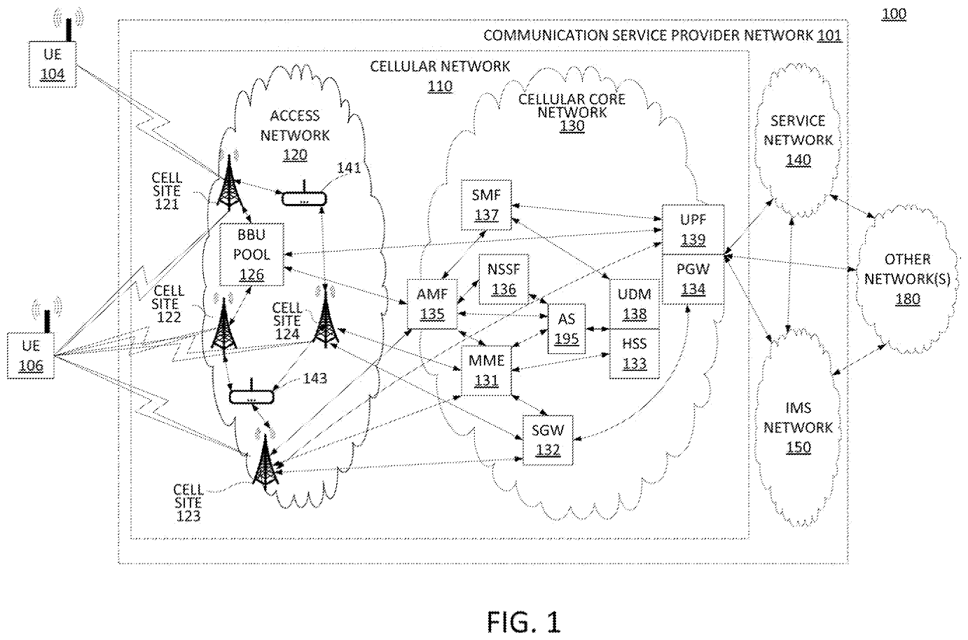

Within the context of the present disclosure, “boosting” the radio frequency signals of a node is understood to refer to the act of routing network traffic between a user endpoint device and another endpoint (e.g., another user endpoint device or an endpoint device in the network, such as an application server) via the node whose radio frequency signals have been boosted. For instance, “boosting” the uplink signals of a node involves routing uplink traffic to that node, while “boosting” the downlink signals of the node involves routing downlink traffic to that node. These and other aspects of the present disclosure are discussed in greater detail in connection with FIGS. 1-4, below.

FIG. 1 illustrates an example network, or system, 100 in which examples of the present disclosure may operate. In one example, the system 100 includes a communication service provider network 101. The communication service provider network 101 may comprise a cellular network 110 (e.g., a 5G network, a 4G/Long Term Evolution (LTE)/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a radio access network (RAN), such as a cloud RAN, a distributed RAN (D-RAN), a centralized RAN (C-RAN), a virtualized RANS (V-RAN), an open RAN (O-RAN), or the like. As part of the migration of cellular networks towards 5G, a RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs) or radio units (RUs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as MIMO antennas, and millimeter wave antennas.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In one example, baseband unit functionality may be split into a centralized unit (CU) and a distributed unit (DU). In addition, the CU and the DU may be physically separate from one another. For instance, a DU may be situated with an RU/RRH at a cell site, while a CU may be in a centralized location hosting multiple CUs. Alternatively, or in addition, a single CU may serve multiple DUs and/or RUs/RRHs. In accordance with the present disclosure a “base station” may therefore comprise at least a BBU (e.g., in one example, a CU and/or a DU), and may further include at least one RRH/RU.

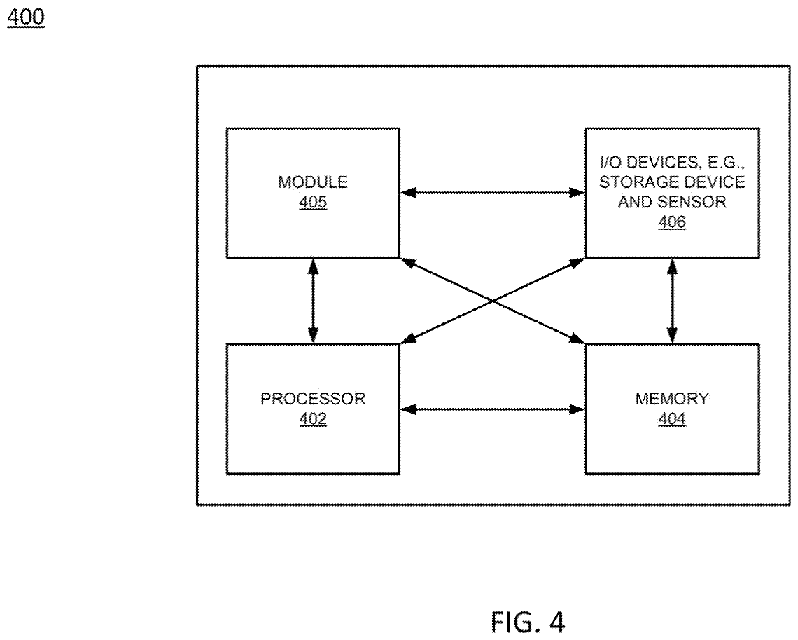

In accordance with the present disclosure, any one or more of cell sites 121-124 may be deployed with antenna and radio infrastructures, including MIMO and millimeter wave antennas. Furthermore, in accordance with the present disclosure, a base station (e.g., cell sites 121-124 and/or baseband units within BBU pool 126) may comprise all or a portion of a computing system, such as computing system 400 as depicted in FIG. 4, and may be configured to perform steps, functions, and/or operations in connection with examples of the present disclosure for selectively boosting the radio frequency signals of wireless base stations.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the access network 120 may further comprise one or more repeaters 141 and 143 to boost the RF signals emitted by the cell sites 121-124. For instance, where any of the cell sites 121-124 emit millimeter wave frequency signals, a repeater 141 or 143 may be deployed in a location that is within the coverage of the millimeter wave signals emitted by two or more of the cell sites 121-124. For instance, the repeater 141 may be deployed in a location within the coverage of any millimeter wave signals emitted by the cell sites 121 and 124, while the repeater 143 may be deployed in a location within the coverage of any millimeter wave signals emitted by the cell sites 122, 123, and 124.

The repeater 141 may monitor the uplink and downlink traffic conditions at the cell sites 121 and 124, while the repeater 143 may monitor the uplink and downlink traffic conditions at the cell sites 122, 123, and 124. In one example, information about the uplink and downlink traffic conditions at any of the cell sites 121-124 may be retrieved by a repeater 141 or 143 from a device in the core network 130, such as the application server (AS) 195, from a database, or from another component. The repeaters 141 and 143 may utilize the information about the uplink and downlink traffic conditions to selectively boost signals from the cell sites 121-124.

For instance, if the repeater 141 determines that the unused capacity of the cell site 121 in the millimeter wave frequency band is above a predefined threshold, but that the unused capacity of the cell site 124 in the millimeter wave frequency band is at or below that predefined threshold, then the repeater 141 may boost the millimeter wave frequency signals emitted by the cell site 121 without boosting the millimeter wave frequency signals emitted by the cell site 124, in order to extend the coverage of the cell site 121 without worsening congestion at the cell site 124. The repeater 143 may perform similar functions for the cell sites 122, 123, and 124.

In one example, selective boosting of the millimeter wave frequency signals emitted by the cell sites 121-124 may include boosting uplink signals without boosting downlink signals, or vice versa. For instance, if the repeater 141 determines that the unused uplink capacity of the cell site 121 is above the predefined threshold, but that the unused downlink capacity of the cell site 121 is at or below that predefined threshold, then the repeater 141 may boost the uplink signals of the cell site 121 without boosting the downlink signals of the cell site 121. However, if the repeater 141 determines that the unused downlink capacity of the cell site 124 is above the predefined threshold, but that the unused uplink capacity of the cell site 124 is at or below that predefined threshold, then the repeater 141 may boost the downlink signals of the cell site 124 without boosting the uplink signals of the cell site 124. Thus, the repeater 141 may boost the uplink signals of the cell site 121 with the greatest unused uplink capacity while simultaneously boosting the downlink signals of a different cell site 124 with the greatest unused downlink capacity. Thus, the repeater 141 may route uplink traffic from UEs 104 and 106 to the cell site 121 while simultaneously routing downlink traffic to the UEs 104 and 106 to the cell site 124. The repeater 143 may perform similar functions for the cell sites 122, 123, and 124.

The repeaters 141 and 143 may continuously monitor the uplink and downlink traffic conditions at their respective cell sites, and may dynamically adjust the manner in which the uplink and downlink signals of those respective cell sites are selectively boosted in response to changes in the traffic conditions.

In one example, each of the repeaters 141 and 143 may comprise all or a portion of a computing system, such as computing system 400 depicted in FIG. 4, and may be configured to perform steps, functions, and/or operations in connection with examples of the present disclosure for selectively boosting the radio frequency signals of wireless base stations. In this regard, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network nodes such as Mobility Management Entity (MME) 131 and Serving Gateway (SGW) 132 support various functions as part of the cellular network 110. For example, MME 131 is the control node for LTE access network components, e.g., eNodeB aspects of cell sites 121-124. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 5G network components, 3G network components, etc. Thus, cellular core network 130 may comprise an integrated network, e.g., including any two or more of 2G-5G infrastructures and technologies (or any future infrastructures and technologies to be deployed, e.g., 6G), and the like. For example, as illustrated in FIG. 1, cellular core network 130 further comprises 5G components, including: an access and mobility management function (AMF) 135, a network slice selection function (NSSF) 136, a session management function (SMF) 137, a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., a “5GC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1. It should be noted that intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. Each of the UEs 104 and 106 may comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). For instance, each of the UEs 104 and 106 may include one or more radio frequency (RF) transceivers for cellular communications and/or for non-cellular wireless communications. In one example, each of the UEs 104 and 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive and/or to transmit multi-path and/or spatial diversity signals.

As illustrated in FIG. 1, UE 104 may access wireless services via the cell site 121 (e.g., NR alone, where cell site 121 comprises a gNB), while UE 106 may access wireless services via any of the cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via one or multiple gNBs (e.g., cell sites 121 and 122 and/or cell sites 121 and 122 in conjunction with BBU pool 126 and/or various other components, such as a CU and/or a DU). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for carrier aggregation and/or dual connectivity. Similarly, UE 106 may communicate with any of the cell sites 121 and 122 using carrier aggregation (CA) (e.g., in accordance with a CA technique). Furthermore, either or both of NR/5G and or EPC (4G/LTE) core network components may manage the communications between UE 106 and the cellular network 110 via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band between 1 GHz and 7.125 GHz. In contrast, an antenna array for 4G may be designed for operation in a frequency band less than 5 GHz, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of the cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. Thus, these and other modifications are all contemplated within the scope of the present disclosure.

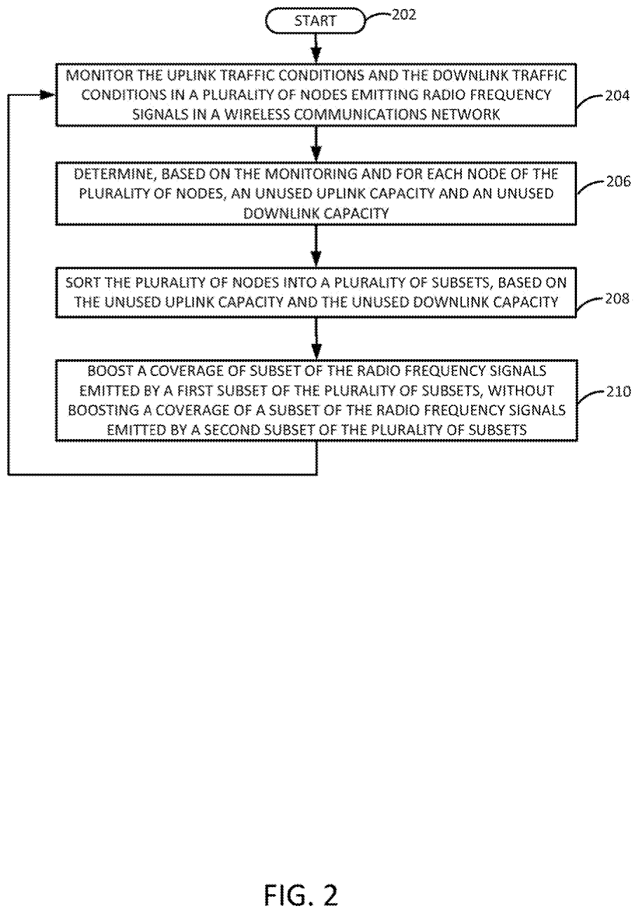

To further aid in understanding the present disclosure, FIG. 2 illustrates a flowchart of an example method 200 for selectively boosting the radio frequency signals of wireless base stations, in accordance with the present disclosure. In one example, the method 200 may be performed at least in part by a repeater that is configured to monitor and selectively boost the signals of a plurality of cellular base stations, such as the repeater 141 or the repeater 143 illustrated in FIG. 1 (or one or more components thereof). However, in other examples, the method 200 may be performed by another device, such as the processor 402 of the system 400 illustrated in FIG. 4. For the sake of example, the method 200 is described as being performed by a processing system.

The method 200 begins in step 202. In step 204, the processing system may monitor uplink traffic conditions and/or downlink traffic conditions in a plurality of nodes emitting radio frequency signals in a wireless communications network.

In one example, the plurality of nodes may comprise 5G millimeter wave nodes or base stations of the wireless communications network. Thus, the radio frequency signals emitted by the plurality of nodes may comprise millimeter wave frequencies (e.g., frequencies in the range of in the range of 24 GHz to 40 GHz).

The processing system may be part of a repeater that is positioned to detect the radio frequency signals emitted by all of the nodes of the plurality of nodes. In one example, the repeater may monitor the uplink traffic conditions and/or the downlink traffic conditions in each of the nodes by retrieving one or more key performance indicators from a data source in the wireless communications network. For instance, an application server or a database may store key performance indicators for the plurality of nodes. These key performances indicators may comprise measurements that are continuously measured, recorded, and refreshed by network probes or other sensors. Thus, as new key performance indicators are recorded, old (e.g., previously recorded) key performance indicators may age out and be deleted.

In one example, the key performance indicators may include at least one of uplink traffic volume (e.g., number of packets or bytes per unit of time), downlink traffic volume (e.g., number of packets or bytes per unit of time), uplink bandwidth consumption, downlink bandwidth consumption, uplink data speed, downlink data speed, and/or other metrics.

In step 206, the processing system may determine, based on the monitoring and for each node of the plurality of nodes, an unused uplink capacity and/or an unused downlink capacity.

In one example, each node of the plurality of nodes may have a known uplink capacity and/or a known downlink capacity. The processing system may estimate, based on the known uplink capacity of a given node of the plurality of nodes and on the information (e.g., key performance indicators) obtained from the monitoring, what the unused uplink capacity of the given node is at any time. Similarly, the processing system may estimate, based on the known downlink capacity of the given node and on the information obtained from the monitoring, what the unused downlink capacity of the given node is at any time.

In step 208, the processing system may sort the plurality of nodes into a plurality of subsets, based on the unused uplink capacity and/or the unused downlink capacity. In one example, the plurality of subsets includes at least a first subset and a second subset. Each of the first subset and the second subset may contain anywhere from zero to n members, where n is equal to the number of nodes in the plurality of nodes. In one example, the first subset of nodes may comprise nodes of the plurality of nodes for which the unused capacity (e.g., bandwidth) in the uplink and/or downlink direction is above a predefined threshold. That is, the nodes of the first subset of nodes may have excess capacity in the uplink direction, the downlink direction, or both. Conversely, the second subset of nodes may comprise nodes of the plurality of nodes for which the unused capacity (e.g., bandwidth) in the uplink and/or downlink direction is below the predefined threshold. That is, the capacity or usage of the nodes of the second subset in the uplink direction, the downlink direction, or both may be at or near its limit.

In one example, each data point in each subset of the first subset and the second subset may comprise: (1) an identifier of a node of the plurality of nodes belonging to the subset; and (2) an indicator indicating whether the uplink capacity, the downlink capacity, or both the uplink capacity and the downlink capacity of the node identified by the identifier meets the criteria for the subset (e.g., at or below the threshold versus above the threshold for unused capacity).

In another example, the processing system may sort the plurality of nodes into four subsets based on the monitoring: a first subset, a second subset, a third subset, and a fourth subset. Each of the first subset, the second, the third subset, and the fourth subset may contain anywhere from zero to n members. For instance, the first subset may include nodes whose unused capacity in the uplink direction is above the predefined threshold, the second subset may include nodes whose unused capacity in the downlink direction is above the predefined threshold, the third subset may include nodes whose unused capacity in the uplink direction is at or below the predefined threshold, and the fourth subset may include nodes whose unused capacity in the downlink direction is at or below the predefined threshold.

In step 210, the processing system may boost a coverage of a subset of the radio frequency signals emitted by a first subset of the plurality of subsets, without boosting a subset of the radio frequency signals emitted by a second subset of the plurality of subsets. In one example, the first subset comprises a subset in which all members (nodes) belonging to the subset have unused capacity that exceeds the predefined threshold in the uplink direction, the downlink direction, or both the uplink direction and the downlink direction. Conversely, the second subset comprises a subset in which all members (nodes) belonging to the subset have unused capacity that is equal to or less than the predefined threshold in the uplink direction, the downlink direction, or both the uplink direction and the downlink direction.

In one example, as discussed above, boosting the subset of the radio signals belonging to the first subset may involve selectively routing uplink and/or downlink traffic to/from user endpoint devices via the nodes belonging to the first subset. Conversely, the uplink and/or downlink traffic may not be routed via the nodes belonging to the second subset.

As discussed above, in one example, sorting of the nodes into the plurality of subsets may involve differentiating between whether the unused capacity at a given node is uplink capacity, downlink capacity, or both uplink and downlink capacity. For instance, the unused uplink capacity at a first node of the plurality of nodes may exceed the predefined threshold (e.g., uplink capacity to spare), while the unused downlink capacity at the same first node may be equal to or less than the predefined threshold (e.g., little to no downlink capacity to spare). The unused uplink capacity at a second node of the plurality of nodes may be equal to or less than the predefined threshold (e.g., little to no uplink capacity to spare), while the unused downlink capacity at the same second node may exceed the predefined threshold (e.g., downlink capacity to spare). Both the unused uplink capacity and unused downlink capacity at a third node of the plurality of nodes may exceed the predefined threshold (e.g., capacity to spare in both directions), while both the unused uplink capacity and unused downlink capacity at a fourth node of the plurality of nodes may be equal to or less than the predefined threshold (no capacity to spare in either direction). In this example, the processing system may route uplink traffic to the first and/or third node while routing downlink traffic to the second and/or third node.

In other examples where more than one node has unused capacity in the uplink or downlink direction, the processing system may route uplink and/or downlink network traffic for a user endpoint device via more than one of the nodes having the unused capacity in order to provide even higher data speeds.

In other examples, where no nodes have sufficient unused capacity (in either the uplink or the downlink direction), the processing system may choose not to route the network traffic for a user endpoint device via any of the nodes. In other words, the processing system will not boost the coverage of any of the radio frequency signals.

The method 200 may return to step 204, and may proceed as described above to continue monitoring the uplink and downlink traffic in the plurality of nodes and to selectively boost radio frequency signals emitted by at least some of the plurality of nodes based on the monitoring. Thus, steps 204-210 may be continuously repeated. This may result in the membership of the first subset of nodes and the second subset of nodes changing over time as traffic conditions in the plurality of nodes change, which may further result in the processing system adjusting which radio frequency signals are boosted and which radio frequency signals are not boosted.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

Thus, examples of the present disclosure provide increased coverage for millimeter wave radio frequency signals (and, potentially, other types of radio frequency signals), without little to no loss in data speed, by monitoring a plurality of millimeter wave nodes and routing network traffic via one or more of the millimeter waves nodes that have the greatest amount of unused capacity.

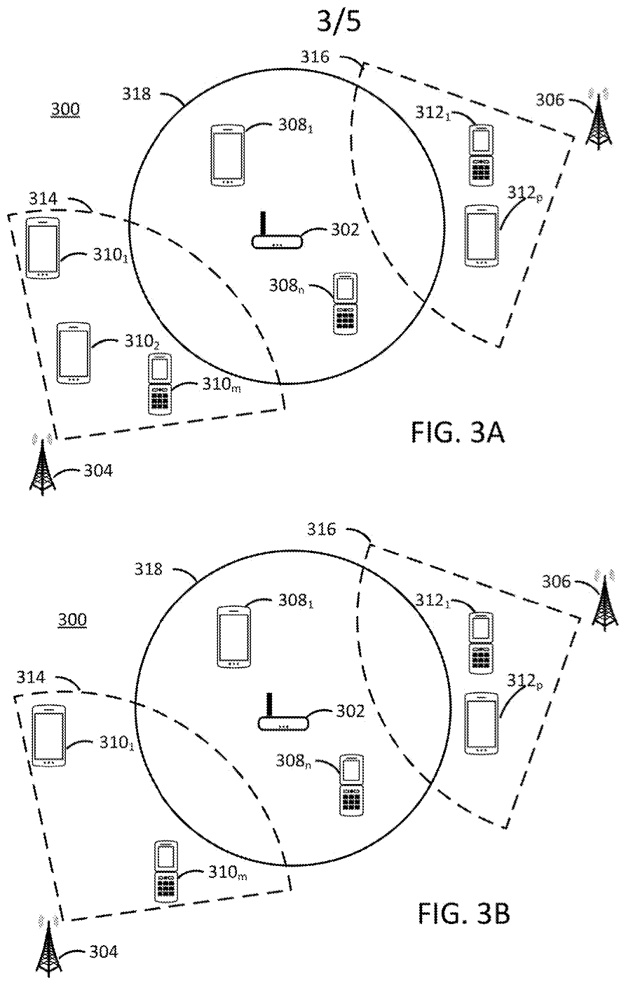

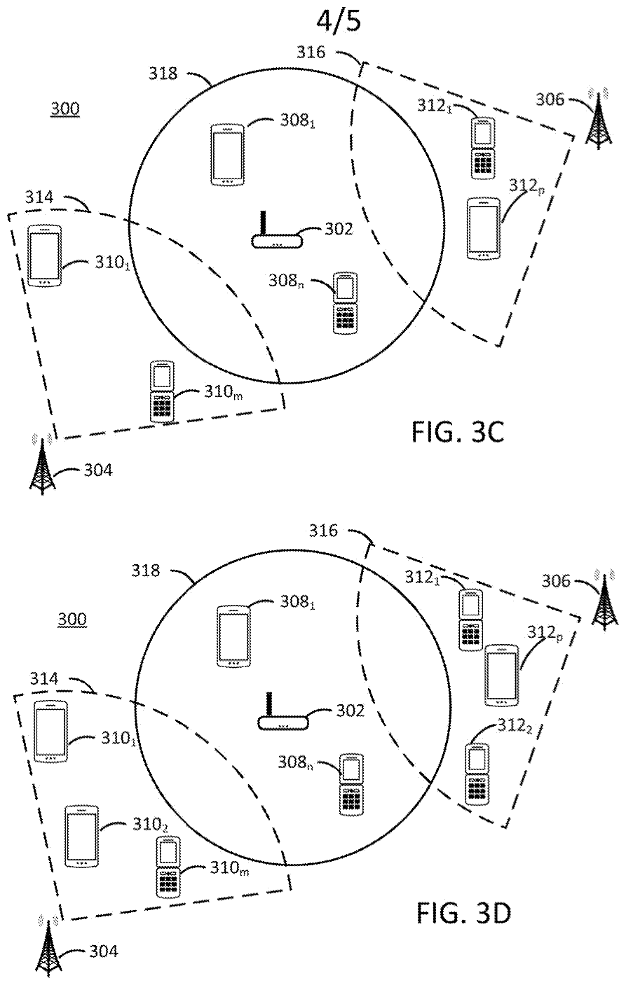

For instance, FIGS. 3A-3D illustrate a portion of an example network 300 in which a repeater 302 of the present disclosure is positioned to detect radio frequency signals emitted by both a first radio frequency node 304 and a second radio frequency node 306. As illustrated, the detection range 318 of the repeater 302 is large enough to be able to detect radio frequency signals (e.g., millimeter wave signals) emitted by the first radio frequency node 304 and the second radio frequency node 306, respectively. The repeater 302 may also be in communication with a data source (not shown) that stores a plurality of key performance indicators for the first radio frequency node 304 and the second radio frequency node 306. The repeater 302 may also be in communication with one or more user endpoint devices 308₁-308ₙ (hereinafter individually referred to as a “user endpoint device 308” or collectively referred to as “user endpoint devices 308”) which are physically located outside the coverage areas 314 and 316 of the first radio frequency node 304 and the second radio frequency node 306, respectively.

User endpoint devices 310₁-310ₘ (hereinafter individually referred to as a “user endpoint device 310” or collectively referred to as “user endpoint devices 310”) are physically located within the coverage area 314 of the first radio frequency node 304 and consume at least a portion of the capacity of the first radio frequency node 304. User endpoint devices 312₁-312ₚ (hereinafter individually referred to as a “user endpoint device 312” or collectively referred to as “user endpoint devices 312”) are physically located within the coverage area 316 of the second radio frequency node 306 and consume at least a portion of the capacity of the first radio frequency node 306.

In the example illustrated in FIG. 3A, the unused capacity of the first radio frequency node 304 may be equal to or less than a predefined threshold (e.g., there may be relatively little unused capacity), while the unused capacity of the second radio frequency node 306 may be greater than the predefined threshold (e.g., there may be a relatively larger amount of unused capacity). In this case, the repeater 302 may choose to route uplink traffic from and downlink traffic to the user endpoint devices 308 via the second radio frequency node 306, making use of the unused capacity of the second radio frequency node 306. Since the first radio frequency node 304 has relatively little unused capacity, the repeater 302 may choose not to route uplink traffic from and downlink traffic to the user endpoint devices 308 via the first radio frequency node 304. In other words, the repeater 302 may boost the coverage of the second radio frequency node 306 only.

In the example illustrated in FIG. 3B, the unused capacity of the first radio frequency node 304 may be greater than the predefined threshold, and the unused capacity of the second radio frequency node 306 may also be greater than the predefined threshold (i.e., both the first radio frequency node 304 and the second radio frequency node 306 may have a significant amount of unused capacity). In this case, the repeater 302 may choose to route uplink traffic from and downlink traffic to the user endpoint devices 308 via the first radio frequency node 304 and the second radio frequency node 306, making use of the unused capacity of both radio frequency nodes 304 and 306. In other words, the repeater 302 may boost the coverage of both the first radio frequency node 304 and the second radio frequency node 306 only.

In the example illustrated in FIG. 3C, the unused capacity of the first radio frequency node 304 may be equal to or less than the predefined threshold in the uplink direction, but greater than the predefined threshold in the downlink direction. Conversely, the unused capacity of the second radio frequency node 306 may be equal to or less than a predefined threshold in the downlink direction, but greater than the predefined threshold in the uplink direction. In this case, the repeater 302 may choose to route uplink traffic from the user endpoint devices 308 via the second radio frequency node 306 (making use of the unused uplink capacity of the second radio frequency node 306) while simultaneously routing downlink traffic to the user endpoint devices 308 via the first radio frequency node 304 (making use of the unused downlink capacity of the first radio frequency node 304). Since each of the first radio frequency node 304 and the second radio frequency node 306 has significant unused capacity, but only in one direction, the repeater 302 may choose to route only one direction of traffic via each of the radio frequency nodes. In other words, the repeater 302 may boost the coverage of the first radio frequency node 304 in the downlink direction only and boost the coverage of second radio frequency node 306 in the uplink direction only.

In the example illustrated in FIG. 3D, the unused capacity of the first radio frequency node 304 may be equal to or less than the predefined threshold, and the unused capacity of the second radio frequency node 306 may also be equal to or less than the predefined threshold (e.g., there may be little to no unused capacity at either radio frequency node). In this case, the repeater 302 may choose to route uplink traffic from and downlink traffic to the user endpoint devices 308 via neither of the first radio frequency node 304 or the second radio frequency node 306. In other words, since neither radio frequency node has sufficient unused capacity, the repeater 302 may choose not to boost the coverage of either radio frequency node. Thus, the user endpoint devices 308 may not be able to obtain millimeter wave coverage in this case.

FIG. 4 depicts a high-level block diagram of a computing device specifically programmed to perform the functions described herein. For example, any one or more components or devices illustrated in FIG. 1 or described in connection with the method 200 may be implemented as the system 400. For instance, a repeater in a communications network (such as might be used to perform the method 200) could be implemented as illustrated in FIG. 4.

As depicted in FIG. 4, the system 400 comprises a hardware processor element 402, a memory 404, a module 405 for selectively boosting the radio frequency signals of wireless base stations, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for selectively boosting the radio frequency signals of wireless base stations may include circuitry and/or logic for routing network traffic through cellular base stations. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 405 for selectively boosting the radio frequency signals of wireless base stations (e.g., a software program comprising computer-executable instructions) can be loaded into memory 404 and executed by hardware processor element 402 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for selectively boosting the radio frequency signals of wireless base stations (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
monitoring, by a processing system including at least one processor, uplink traffic conditions and downlink traffic conditions in a plurality of nodes emitting radio frequency signals in a wireless communications network;
determining, by the processing system based on the monitoring and for each node of the plurality of nodes, an unused uplink capacity and an unused downlink capacity;
sorting, by the processing system, the plurality of nodes into a plurality of subsets, based on the unused uplink capacity and the unused downlink capacity; and
boosting, by the processing system, a first subset of the radio frequency signals emitted by a first subset of the plurality of subsets, without boosting a second subset of the radio frequency signals emitted by a second subset of the plurality of subsets.

2. The method of claim 1, wherein the plurality of nodes comprises fifth generation millimeter wave nodes of the wireless communications network, and the radio frequency signals comprise millimeter wave frequencies.

3. The method of claim 1, wherein the processing system is part of a repeater that is positioned to detect the radio frequency signals emitted by all of the nodes of the plurality of nodes.

4. The method of claim 1, wherein the monitoring comprises retrieving a plurality of key performance indicators from a data source in the wireless communications network, and wherein the key performance indicators are recorded by at least one sensor in the wireless communications network.

5. The method of claim 4, wherein the plurality of key performance indicators comprises, for each node of the plurality of nodes, at least one of: an uplink traffic volume, a downlink traffic volume, an uplink bandwidth consumption, a downlink bandwidth consumption, an uplink data speed, or a downlink data speed.

6. The method of claim 4, wherein the determining comprises:
estimating, based on a known uplink capacity of the each node and on the plurality of key performance indicators, the unused uplink capacity; and
estimating, based on a known downlink capacity of the each node and on the plurality of key performance indicators, the unused downlink capacity.

7. The method of claim 1, wherein the first subset of the plurality of subsets contains nodes of the plurality of nodes for which the at least one of: the unused uplink capacity or the unused downlink capacity is greater than a predefined threshold.

8. The method of claim 7, wherein the second subset of the plurality of subsets contains nodes of the plurality of nodes for which the at least one of: the unused uplink capacity or the unused downlink capacity is equal to or less than the predefined threshold.

9. The method of claim 1, wherein the boosting the first subset of the radio frequency signals emitted by the first subset of the plurality of subsets comprises routing network traffic between a user endpoint device of the wireless communications network and another endpoint of the wireless communications network via nodes of the plurality of nodes that are contained within the first subset of the plurality of subsets.

10. The method of claim 9, wherein the user endpoint device is physically located outside of a coverage area of the nodes of the plurality of nodes that are contained within the first subset of the plurality of subsets prior to the boosting.

11. The method of claim 1, wherein the plurality of subsets comprises:
the first subset, wherein the unused uplink capacity of nodes of the plurality of nodes contained within the first subset is above a predefined threshold;
the second subset, wherein the unused uplink capacity of nodes of the plurality of nodes contained within the second subset is equal to or below the predefined threshold;
a third subset, wherein the unused downlink capacity of nodes of the plurality of nodes contained within the third subset is above the predefined threshold; and
a fourth subset, wherein the unused downlink capacity of nodes of the plurality of nodes contained within the fourth subset is equal to or below the predefined threshold.

12. The method of claim 11, wherein the boosting comprises routing uplink network traffic from a user endpoint device to another endpoint in the wireless communications network via at least one node contained in the first subset of the plurality of subsets.

13. The method of claim 12, wherein the boosting further comprises routing downlink network traffic to the user endpoint device from the another endpoint in the wireless communications network via at least one node contained in the third subset of the plurality of subsets.

14. The method of claim 12, wherein the user endpoint device is physically located outside of a coverage area of the at least one node contained in the first subset of the plurality of subsets and the at least one node contained in the third subset of the plurality of subsets prior to the boosting.

15. The method of claim 1, further comprising:
continuously repeating, by the processing system, the monitoring, the determining, the sorting, and the boosting.

16. The method of claim 15, wherein a repetition of the sorting results in a change in membership to at least one subset of the plurality of subsets as a result of a repetition of the determining.

17. A non-transitory computer-readable medium storing instructions which, when executed by a processing system including at least one processor, cause the processing system to perform operations, the operations comprising:
monitoring uplink traffic conditions and downlink traffic conditions in a plurality of nodes emitting radio frequency signals in a wireless communications network;
determining, based on the monitoring and for each node of the plurality of nodes, an unused uplink capacity and an unused downlink capacity;
sorting the plurality of nodes into a plurality of subsets, based on the unused uplink capacity and the unused downlink capacity; and
boosting a first subset of the radio frequency signals emitted by a first subset of the plurality of subsets, without boosting a second subset of the radio frequency signals emitted by a second subset of the plurality of subsets.

18. The non-transitory computer-readable medium of claim 17, wherein the plurality of subsets comprises:
the first subset, wherein the unused uplink capacity of nodes of the plurality of nodes contained within the first subset is above a predefined threshold;
the second subset, wherein the unused uplink capacity of nodes of the plurality of nodes contained within the second subset is equal to or below the predefined threshold;
a third subset, wherein the unused downlink capacity of nodes of the plurality of nodes contained within the third subset is above the predefined threshold; and
a fourth subset, wherein the unused downlink capacity of nodes of the plurality of nodes contained within the fourth subset is equal to or below the predefined threshold.

19. The non-transitory computer-readable medium of claim 18, wherein the boosting comprises:
routing uplink network traffic from a user endpoint device to another endpoint in the wireless communications network via at least one node contained in the first subset of the plurality of subsets; and
routing downlink network traffic to the user endpoint device from the another endpoint in the wireless communications network via at least one node contained in the third subset of the plurality of subsets.

20. A device comprising:
a processing system including at least one processor; and
a computer-readable medium storing instructions which, when executed by the processing system, cause the processing system to perform operations, the operations comprising:
monitoring uplink traffic conditions and downlink traffic conditions in a plurality of nodes emitting radio frequency signals in a wireless communications network;
determining, based on the monitoring and for each node of the plurality of nodes, an unused uplink capacity and an unused downlink capacity;
sorting the plurality of nodes into a plurality of subsets, based on the unused uplink capacity and the unused downlink capacity; and
boosting a first subset of the radio frequency signals emitted by a first subset of the plurality of subsets, without boosting a second subset of the radio frequency signals emitted by a second subset of the plurality of subsets.
